(19) United States
(12) Patent Application Publication
(10) Pub. No.: US 2016/0228911 A1
(43) Pub. Date: Aug. 11, 2016

(54) SPRAY COATING SYSTEM FOR FIBER WEB

(71) Applicant: BMGI Corporation, Denver, CO (US)

(72) Inventors: David Silverstein, Longmont, CO (US); Riaan Brits, Boulder, CO (US); Brian Miller, Denver, CO (US); Philip Samuel, Lafayette, CO (US)

(21) Appl. No.: 14/617,809

(22) Filed: Feb. 9, 2015

(51) Int. Cl. B05D 1/02; B05D 1/04

(52) U.S. Cl. CPC B05D 1/02; B05D 1/04

(57) ABSTRACT

The invention relates to a method for ensuring even and consistent application of a treating agent onto a fiber web. The method of the invention improves coating agent deposition process such that the fiber web is evenly coated using less raw material by improving the deposition method and atomization quality, better control of the deposition rate and improving the adhesion properties. The method collects a treating agent in a chamber directing the agent through a linear continuous nozzle onto a fiber web. The treating agent is electrostatically charged and ultrasonically nebulized before being directed towards the fiber web.

### BACKGROUND OF THE INVENTION

1. Field of the Invention

The present invention relates to a spray coating system. More specifically, the present invention relates to a spray coating system for fiber web.

2. Description of the Related Art

Treating agents are typically applied to fiber webs to augment the functionality of the fiber web beyond that of a non-treated fiber web. The composition of the treating agent depends on the functionality desired from the fiber web.

The fiber web surface may, depending on the material from which the web is manufactured, be uneven. In paper and paperboard manufacturing, non-coated paper and paperboard surfaces generally assume the shape and local contour of the pulp and wood fiber at the surface of the paper or paperboard. This material profile may be undesired for downstream processing or use.

In the manufacture of fiber webs such as paper and paperboard, treating agents such as coatings are applied to augment the functionality of the fiber web. For example, applying a coating to paperboard makes it possible to use the material for diverse packaging purposes, ranging from preserving dry goods (such as tobacco) to perishables (such as frozen food). The requirements of the coating depends on the appearance and performance expected of the surface of the packaging.

Dictated by the desired eventual purpose of the treated fiber web, multiple treating agent applications may be made. An initial treating agent application can be made to improve the evenness of the fiber web such that subsequent treating agent applications can be made to provide the desired surface appearance and performance characteristics, such as smoothness, gloss, whiteness, opacity, and printability. A plurality of applications may be made to effect a result consistent with a desired performance level.

Many different techniques are used for spreading treating agents onto fiber webs. For example, doctor blading (also known as blade or knife coating) describe a series of techniques where a treating agent is brought in direct contact with the fiber web. The treating agent may be applied by submerging the fiber web in the treating agent (held in a pan), spraying the treating agent onto the fiber web, gravity feeding the treating agent onto the fiber web (also known as curtain coating), or using a treating agent applicator. The thickness of the resulting treating agent deposition is governed by a “doctor blade”, also referred to as doctoring. The purpose of the doctor blade is to mechanically remove excess treating agent, thus smoothing the profile of the treating agent on the fiber web. Other than doctoring with a physical scraping device, it is also possible to use a gas (e.g., air) to remove excess coating. The excess coating, which is contaminated by the presence of fiber, is then reclaimed through filtration and recirculation. Unfortunately, a large percentage of the excess coating is wasted due to the inability to completely remove the unwanted fiber therefrom. The application of a treating agent may be followed by the use of nip rolls to improve the bond between treating agent and fiber web.

Transfer coating refers to the process of applying a treating agent to a roller over which a fiber web is moving. Treating agent can be applied in various states, such as a liquid or a gas. Treating agent may be applied to either side of the fiber web. The process may additionally be followed by one or more nip rolls. Nip rolls use close proximity to combine the treating agent and fiber web through modification of parameters such as pressure and temperature.

The techniques mentioned here may also be used without a post-processing step such as doctoring. In such cases, intermediate steps may be taken to ensure that a treating agent profile is consistent with the desired result. An example of an intermediate step may include the guiding of the treating agent over an intermediate planar surface.

There is, therefore, a need in the art for improved systems and methods of spray coating for fiber web.

### SUMMARY OF THE INVENTION

Embodiments of the present invention are concerned with the directing of a treating agent onto a fiber web. The treating agent deposition is improved such that the portion of treating agent directly deposited onto a fiber web is increased. Furthermore, increased deposition of treating agent reduces waste of treating agent, which diminishes the need for potential treating agent screening and recycling.

Additional embodiments may further provide for the application of an insulating or strengthening treating agent, known as a coating, to a fibrous web such as paper or paperboard. The application of a treating agent to paperboard has particular advantages, including, but not limited to, improved strength (e.g., tensile strength, stiffness), improved printability or ink absorption, applicability to food grade applications (e.g., food heating and preparation in domestic grade microwave ovens, odor absorption), surface finish (e.g., smoothness, color, gloss), foldability, and water absorbency.

Embodiments of the present invention may further include methods for directing a treating agent onto a moving fiber web. Such methods may provide that the application of the treating agent result in a beneficial reduction in the volume of treating agent required in order to coat a moving fiber web, minimize the necessity to reclaim and recirculate the excess treating agent that is applied on the surface, and provide improved control on the amount of treatment agent applied on the fiber web to provide the desired surface characteristics. The improved control of the coating process may also allow for an increase in the processing speed as the process is no longer governed by the gravity fed or dipped applications.

In possible embodiments, a treating agent may be collected in a feeding chamber. The feeding chamber may serve to equalize pressure of the treating agent and subsequently direct the treating agent to a linear continuous nozzle system. In another possible embodiment, the feeding chamber may direct the treating agent to a plurality of linear continuous nozzle systems. The linear continuous nozzle system, in contrast to prior art dependent on arrays of spray nozzles, may utilize a uniform slit arrangement which projects and directs the treating agent towards the moving fiber web.

In further embodiments, the treating agent may be modified by the continuous nozzle system such that the adherence to the fiber web is improved. Modification of the treating agent may be realized by atomization induced by a vibrating component internal to the linear, continuous nozzle system. Atomizing treating agents with high viscosity may improve the ability to direct said treating agent where a non-atomized treating agent would be difficult to adequately direct to maintain production requirements.

In a further embodiment, an electrostatic charge may be created in the treating agent to improve the distribution pattern of individual treating agent particles onto the moving fiber web. Atomized treating agent particles may lack sufficient kinetic energy to adhere to the moving fiber web. In exemplary configurations, the fiber web may have a directional momentum perpendicular to the application angle at which treating agent particles are emitted from the spray nozzle. To aid in the directional transfer of treating agent particles, an optional charge, opposite to that of the treating agent, may be induced in the moving fiber web to attract treating agent particles.

In a simple form, the treating agent application method disclosed in the present invention may apply a treating agent to a fiber web once. However, consistent with industry practice and manufacturing requirements, it is possible to apply the method of the present invention multiple times in order to achieve a desired result. Not only does the system create consistency in the finish, but also allows for custom coating effects such as anti-reflectivity coatings. Each embodiment of the present invention may be governed by distinct manufacturing requirements in that the modification of process parameters may guide the process step outcomes. Depending on manufacturing requirements and desired outcomes, treating agent applications may be made to one or both sides of the moving fiber web.

### BRIEF DESCRIPTION OF DRAWINGS

FIG. 1 is a magnification of a cross-section of an exemplary fiber web with a build-up of treating agents to result in a desired finish.

FIG. 2 is a schematic diagram of the top right and top left perspective views of an exemplary arrangement of the treating agent coating system and associated accessories, as well as the moving system of fiber web and respective associated accessories.

FIG. 3 is an orthographic (top, side, and front) view of an exemplary spray coating system.

FIG. 4 is a cross-sectional view of an exemplary sprayer body and how its componentry fits together.

FIG. 5 is an exploded view of internal parts of an exemplary linear, continuous sprayer.

FIG. 6 is a cut-away view of an exemplary linear continuous nozzle tip arrangement.

### DETAILED DESCRIPTION

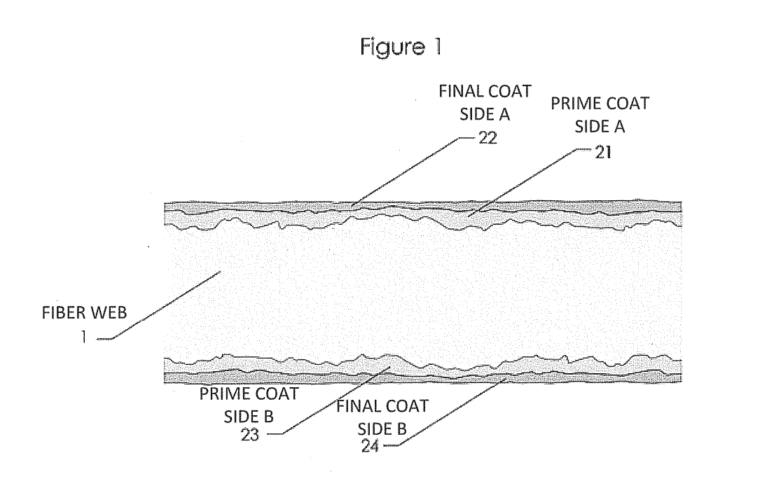

Embodiments of the present invention provide for a fiber web treatment apparatus that coats an oriented fiber web by focusing a pressurized treatment material through a continuous, linear nozzle 25 that utilizes ultrasonic and electrostatic principles to smoothly and efficiently apply a thin coat of material. The fiber web can be passed through a succession of the continuous linear nozzle systems in order to get the proper level of finish desired on the web surface. FIG. 1 illustrates a cross-section of the fiber web 1 where the succession of coats for desired finish can be seen in 21 and 22 for side A and 23 and 24 for side B. A prime coat of treating agent 21 or 23 may first be applied to create an even surface on the uneven fiber web followed by subsequent coats and then a final coat 22 or 24 to provide the desired surface appearance and performance characteristics. Those familiar with the trade will appreciate that multiple treating agent applications could be made on one or both sides of the fiber web in order to be consistent with the predetermined finish characteristics desired.

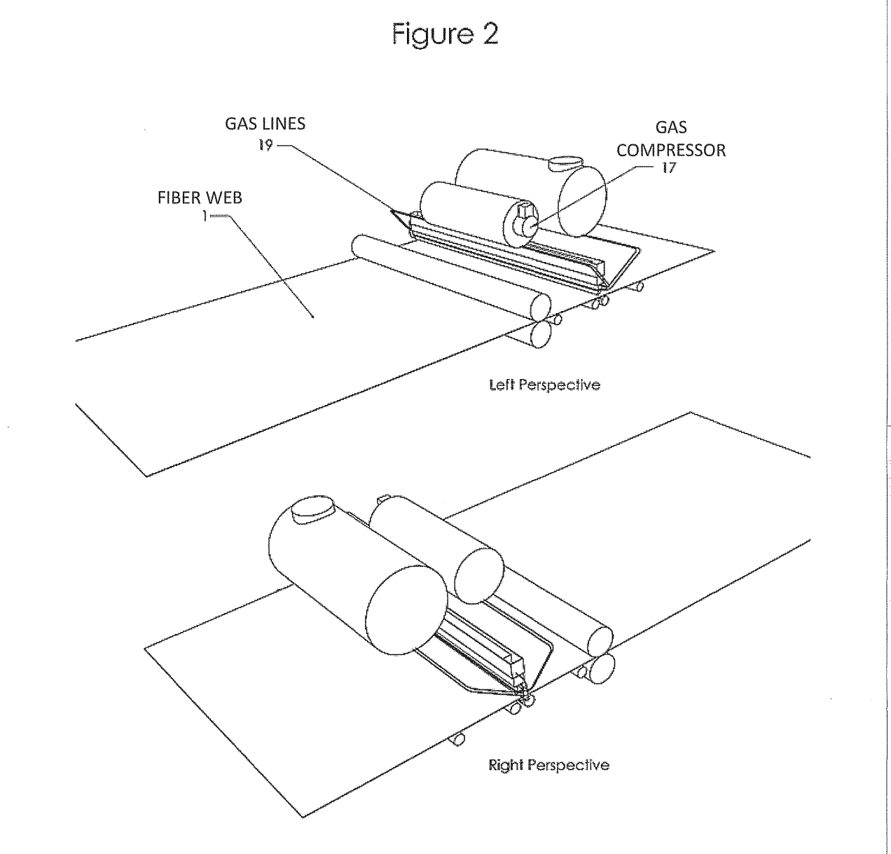

The spray system in FIG. 2 may preferably utilize a continuous, linear spray tip 25 to coat the entire length of a fiber web 1 (4 to 40 ft) at a height range from 0.01 to 3 inches from the surface of the web depending on the variability of pressure and waste due to the viscosity differences in various treatment materials. The various treatment materials can be water-based, solventless, or hot melt materials such as latex, soy, or wax.

The embodiments described herein may all be used independently or in tandem to satisfy the needs of coating thickness and desired finish depending on which coat is being applied (21 or 22, for side A, 23 or 24 for side B) at necessary quantities to keep the production of the fiber web moving at the necessary speed to enable the production goals of the fiber web manufacturing facility. In addition to the treating agent applications 21, 22, 23 and 24, further treating agent applications may be made on top of, for example, coatings 22 or 24, depending on the desired characteristics associated with the fiber web to be treated.

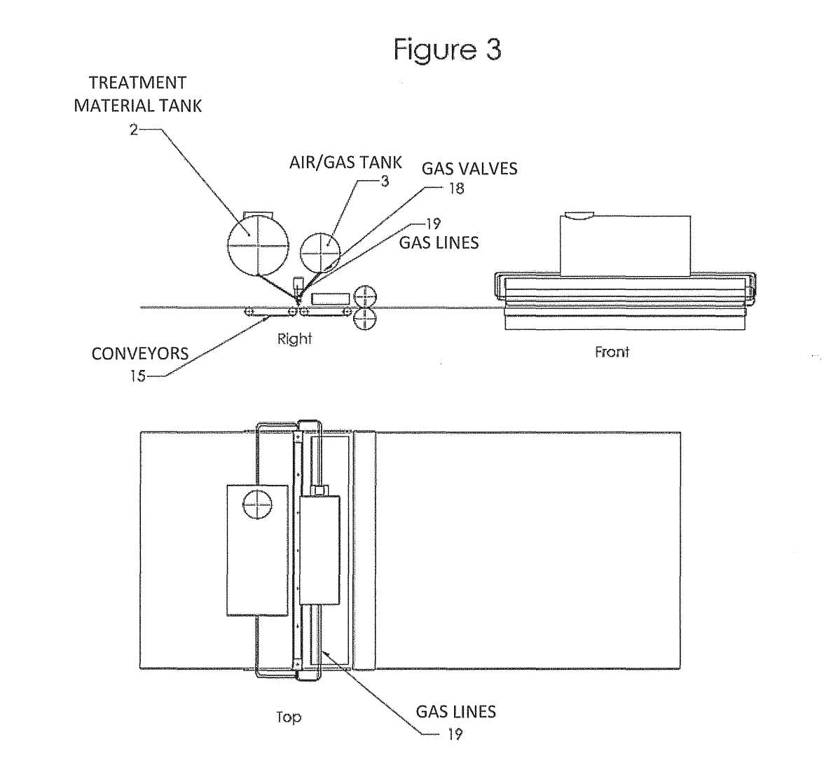

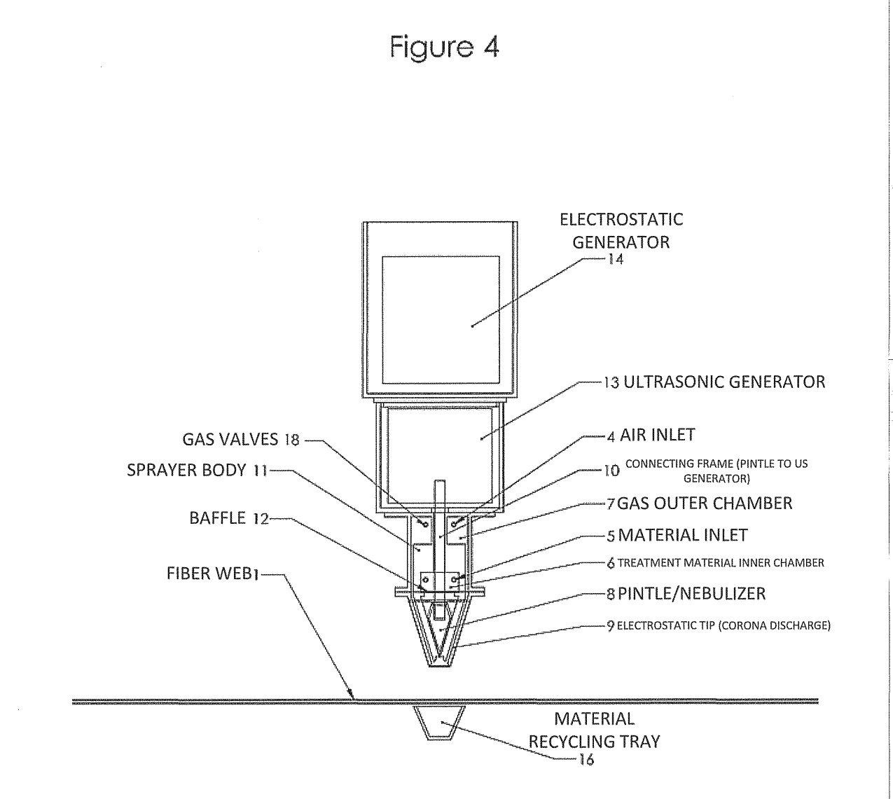

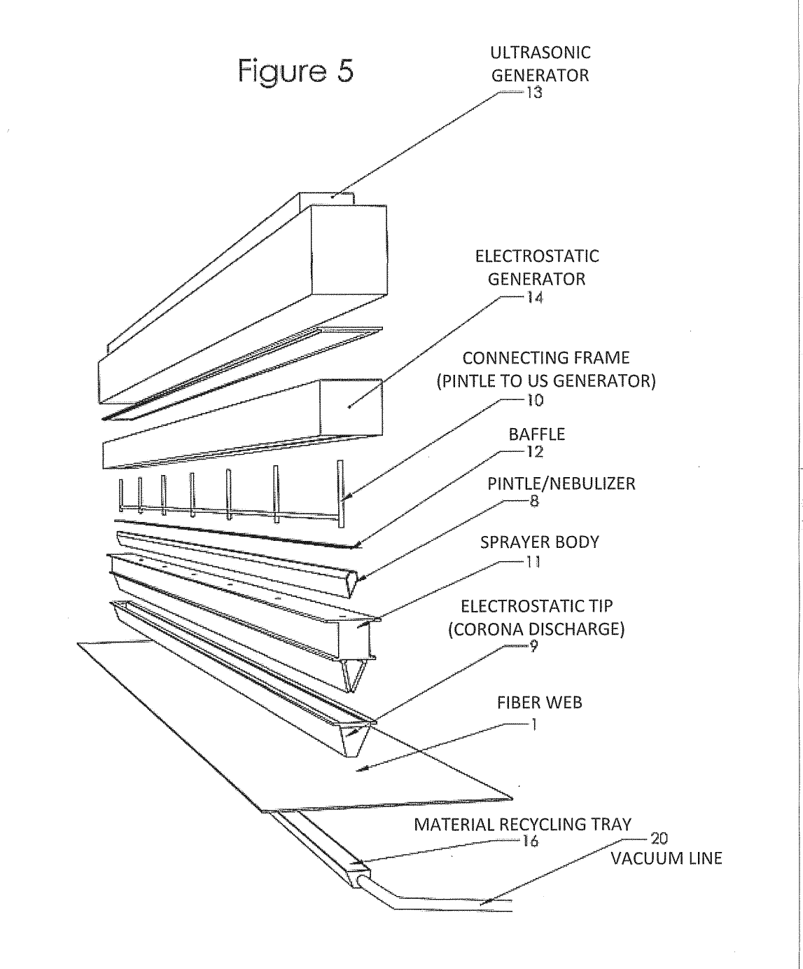

In FIG. 3, the treatment material may first be pumped into the treatment material tank 2 from an outside source such as a tanker truck or from a larger, external tank that can be filled intermittently without disrupting the fiber coating process. From the treatment material tank 2, the treatment material may be pumped, via an internal tank pump, through hard lined pipes 19 connected to both ends of the continuous, linear spray body 11 (FIG. 4 and FIG. 5) in order to supply sufficient material as required to accommodate the coating of a fast-moving fiber web. Once the material enters through the material inlet 5 into the internal chamber 6 (FIG. 4), the material may then pass through a slotted baffle 12 in order to equalize the pressure of the material along the full length of the continuous, linear tip assembly. Just after the treatment material passes through the baffle, the treatment material may surround the pintle 8 of the sprayer assembly.

The pintle 8 may have multiple functions within the system. The pintle may be electrostatically charged by the electrostatic generator 14 and as a result, induces the same charge in treating agent molecules excited by the pintle 8. The pintle 8 may be connected to the ultrasonic generator 13 by a connecting frame 10, so that as the pintle is pulled back to allow material flow, an ultrasonic frequency is produced on the pintle that further breaks apart the similarly charged, somewhat viscous material particles into a mist that spreads evenly across the surface of the fiber web.

The electrostatic charge imparted may be varied to control the treating agent deposition rate. The deposition rate may determine how closely the treating agent mimics the contours of the surface it is deposited on. For example, the base or prime treating agent layer (21 or 23) may have a lower degree of charge, which may lead to treating agent build-up inconsistent with the profile of the fiber web 1. As a result, the treating agent layers (21 or 23) may have a profile more smooth than that of the fiber web 1. An increased electrostatic charge of treating agent intended for subsequent layers (such as 22 or 24), may lead the treating agent particles to mimic more closely the profile of the surface it is deposited on. Such deposition may lead to consistent and even coating of previous deposition layer using less treating agent.

The fiber web 1 passed under the sprayer assembly (FIG. 5) may hold a charge opposite to the charge of the treatment material, promoting even and controllable levels of treating agent across the surface of the fiber web, depending on the degree of charge associated with the treating agent. The fiber web, which may not be electrically conductive, may be grounded by the two conveyors 15 (FIG. 3) below it. The material recycling tray 16 between the two conveyor assemblies may have a charge opposite to the charge of the treatment agent and therefore acts as a collector of any sprayed material when the fiber is not passing through or during the priming or cleaning of the sprayer body. The material recycling tray may be connected to a vacuum line 20 that pulls excess material back into the reservoir for recycling or to a waste container.

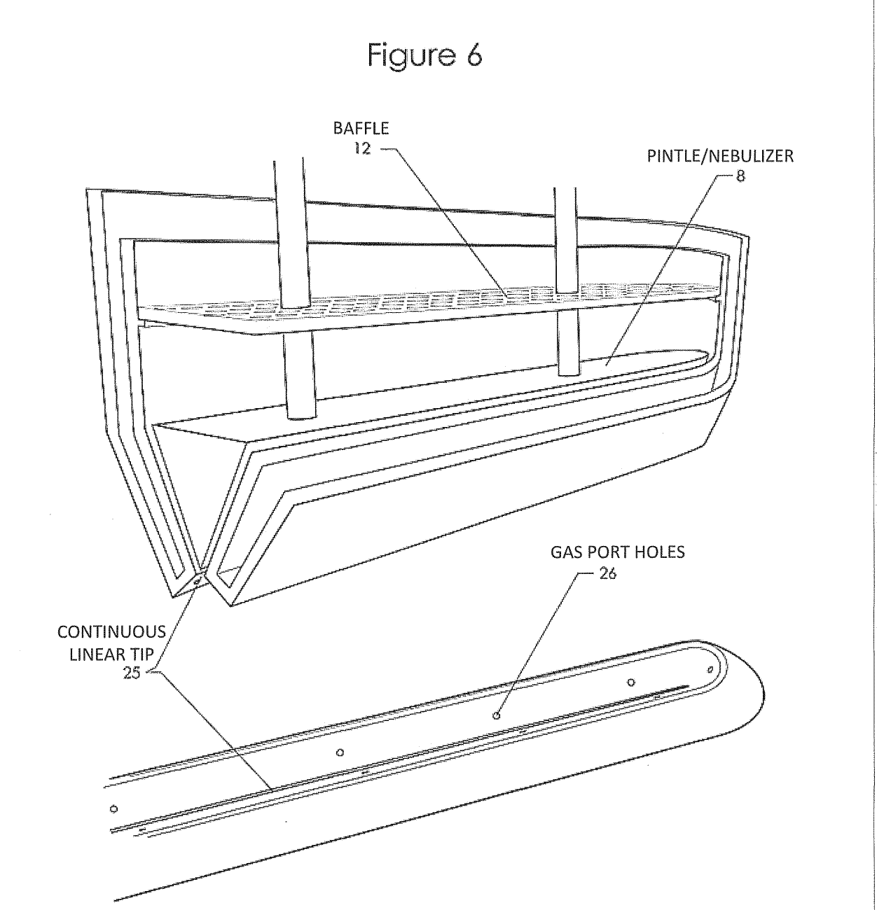

To aid in the application of the mist created by the ultrasonically atomized, electrostatic charged, continuous linear nozzle 25 (FIG. 6), a stream of pressurized gas emitted from the gas ports 26 may help focus the spray of the treatment material in a manner that facilitates the focus the flow of charged treating agent particles, as well as non-mechanically smooth the finish of the treatment material on the web which helps to reduce the waste of treatment material that is considered standard practice. This approach reduces the need for post-processing steps such as nip rolls or doctor blades, commonly used in the industry.

Such a gas system that helps to direct and sharpen the mist created by the ultrasonic and electrostatic spray tip 9 may originate from a gas compressor 17 that charges the gas in gas tank 3. The gas may be regulated at the air inlet 4 of the outer chamber 7, as needed by valves 18 that open or close to create the desired effect on the treatment material by travelling through hard lined tubes 19 that enter into the gas outer chamber 7 of the sprayer body 11. The electrostatic tip of the sprayer may be a metallic housing that may be also connected to the electrostatic generator 14, which may induce a corona discharge to charge the gas and to further charge any treatment material particles that were not previously charged by the pintle 8. Excess gas may, like the treating material, be pulled into the material recycling tray 16 to exhaust to the waste filtration vacuum line 20.

After each application of the treatment material on to the fiber web, the treatment material may then be rapidly cured by a system such as an infrared heater or a heated roller in order to cure the material before the web moves on to successive coating processes on either side of the fiber web.

These embodiments (ultrasonic, electrostatic, linear continuous nozzle and non-reacting gas assist) can be used independently or in any combination and in any order to achieve the desired finish on the fiber web.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for applying a treating agent onto a moving fiber web, the method comprising:
supplying a treating agent for treating the moving fiber web;
forming at least one jet of the treating agent by directing the treating agent through a continuous opening in at least one nozzle system; and
directing the at least one jet of the treating agent toward a surface of the fiber web while the fiber web is moving.

2. The method of claim 1, wherein the nozzle system comprises a treating agent inlet.

3. The method of claim 1, further comprising collecting the treating agent in an inner nozzle chamber or a feeding chamber.

4. The method of claim 3, wherein directing the at least one jet of the treating agent toward the surface of the moving fiber web comprises directing the treated agent collected in the feeding chamber towards the fiber web under pressure.

5. The method of claim 1, wherein directing the at least one jet of the treating agent toward the surface of the moving fiber web comprises using a non-reacting gas to control the treating agent jet pattern.

6. The method of claim 5, wherein the nozzle system comprises a non-reacting gas inlet.

7. The method of claim 5, further comprising directing the non-reacting gas along an outer chamber in the nozzle system.

8. The method of claim 5, further comprising using the non-reacting gas as a guide for the treating agent, wherein a shape and dimension of the treating agent is controlled upon exit from the nozzle system.

9. The method of claim 1, wherein the nozzle system comprises at least one nozzle plate over an ultrasonic nebulizer.

10. The method of claim 9, wherein directing the at least one jet of the treating agent toward a surface of the moving fiber web comprises directing ultrasonically pulsed jets of the treating agent toward the surface of the moving fiber web.

11. The method of claim 10, further comprising atomizing the treating agent from a nozzle inner chamber by combining it with non-reacting gas from an nozzle outer chamber.

12. The method of claim 11, further comprising directing the atomized treating agent toward the ultrasonic nebulizer.

13. The method of claim 12, wherein the atomized treating agent is ultrasonically nebulized.

14. The method of claim 13, wherein directing the at least one jet of the treating agent toward the surface of the moving fiber web comprises directing the atomized and ultrasonically nebulized treating agent toward the moving fiber web.

15. The method of claim 1, further comprising electrostatically charging the treating agent for treating the moving fiber web.

16. The method of claim 15, wherein electrostatically charging the treating agent comprises directing atomized treating agent towards an electrostatic tip/dispenser.

17. The method of claim 16, wherein the atomized treating agent is electrostatically charged by exposure to the electrostatic tip/dispenser.

18. The method of claim 17, further comprising providing an electrostatic charge to the electrostatic tip/dispenser via an electrostatic generator.

19. The method of claim 1, wherein the moving fiber web moves across a moving surface.

20. The method of claim 19, further comprising providing an electrostatic charge to the moving surface via an electrostatic generator.

21. The method of claim 20, wherein the electrostatic charge provided to the moving surface is opposite of a charge applied to the treating agent.
